(19) United States
(12) Patent Application Publication
(10) Pub. No.: US 2026/0126652 A1
(43) Pub. Date: May 7, 2026

(54) VIRTUAL IMAGE DISPLAY APPARATUS AND OPTICAL UNIT

(71) Applicant: SEIKO EPSON CORPORATION, Tokyo (JP)

(72) Inventor: Tokito YAMAGUCHI, AZUMINO-SHI (JP)

(73) Assignee: SEIKO EPSON CORPORATION, Tokyo (JP)

(21) Appl. No.: 19/346,586

(22) Filed: Oct. 1, 2025

(30) Foreign Application Priority Data
Oct. 2, 2024 (JP) 2024-173044

(51) Int. Cl. G02B 27/01; G02B 5/30; G02B 27/00

(52) U.S. Cl. CPC G02B 27/0172; G02B 5/3033; G02B 5/3083; G02B 27/0006; G02B 27/0176; G02B 2027/0178

(57) ABSTRACT

A virtual image display apparatus includes a lens barrel having a first opening through which image light passes; a first lens fixed inside the lens barrel; a sealing member fixed to the first opening and configured to seal the first opening; and an image display panel fixed outside the lens barrel and configured to generate the image light to be output toward the first lens via the sealing member. The sealing member includes a polarization control member configured to convert the image light into predetermined polarized light.

The present application is based on, and claims priority from JP Application Serial Number 2024-173044, filed Oct. 2, 2024, the disclosure of which is hereby incorporated by reference herein in its entirety.

### BACKGROUND

### 1. Technical Field

The present disclosure relates to a virtual image display apparatus and an optical unit that allow observation of a virtual image, and particularly relates to a virtual image display apparatus and an optical unit using a lens barrel that incorporates a lens and is sealed from the outside.

### 2. Related Art

There is a known system including: a central mount; a rotating collar coupled to the central mount and configured to rotate around the central mount; and two or more holding prongs attached to the rotating collar, the holding prongs configured to hold a first lens while the rotating collar rotates the first lens around the optical axis of a pancake lens display assembly including a second lens arranged optically in series with respect to the first lens, the rotating collar configured to rotate the first lens to position a first orientation axis of a quarter waveplate on the first lens in such a way that the first orientation axis inclines by a certain angle with respect to a second orientation axis of a reflective polarizer on the second lens; an illumination source configured to emit test light via the first lens and the second lens; and a sensor configured to receive the test light emitted by the illumination source, the certain angle being an angle at which the light having passed through the second lens and then the first lens is substantially circularly polarized (JP-T-2022-501630).

JP-T-2022-501630 is an example of the related art.

The system described above has a structure in which the panel-side lens surface of the first lens is sealed together with the panel by a lens barrel part. In the structure described above, since a pancake lens portion is not sealed, foreign matter leaking from the interior of the pancake lens or the portion that seals the panel and the lens barrel is likely to adhere to the panel-side lens surface or the panel surface, and the adhesion leads to deterioration of image quality. To improve the quality of an image displayed by a head mounted display (HMD) at the time of the assembly of the panel, even when the angle of rotation of a polarizing element bonded to the panel surface needs to be adjusted in accordance with the direction in which the pancake lens rotates, or the positions in the optical axis direction, the horizontal direction, and the rotation direction need to be adjusted for adjustment of the focusing of a displayed image, there is a risk of interference with the lens barrel part, so that the range of each of the various adjustments is restricted. The panel position adjustment is therefore unlikely to be sufficiently performed, so that the assembly may not be performed with the image quality sufficiently ensured.

### SUMMARY

A virtual image display apparatus according to an aspect of the present disclosure includes a lens barrel having a first opening through which image light passes; a first lens fixed inside the lens barrel; a sealing member fixed to the first opening and configured to seal the first opening; and an image display panel fixed outside the lens barrel and configured to generate the image light to be output toward the first lens via the sealing member, and the sealing member includes a polarization control member configured to convert the image light into predetermined polarized light.

An optical unit according to another aspect of the present disclosure includes a lens barrel having a first opening through which image light passes; a first lens fixed inside the lens barrel; a sealing member fixed to the first opening and configured to seal the first opening; and an image display panel fixed outside the lens barrel and configured to generate the image light to be output toward the first lens via the sealing member, and the sealing member includes a polarization control member configured to convert the image light into predetermined polarized light.

### BRIEF DESCRIPTION OF THE DRAWINGS

FIG. 1 is an exterior front view illustrating a state in which virtual image display apparatuses according to a first embodiment are mounted.

FIG. 2 is a side cross-sectional view illustrating the internal structure of a display optical system.

FIG. 3 is a partial cross-sectional view illustrating detailed structures of portions of the display optical system.

FIG. 4 is a conceptual view illustrating the optical operation of the virtual image display apparatus according to the first embodiment.

FIG. 5 is a perspective cross-sectional view illustrating the structure of a lens barrel in the first embodiment.

FIG. 6 is a perspective cross-sectional view illustrating the structure of the lens barrel in the first embodiment.

FIG. 7 is a partial cross-sectional view illustrating the structure of the lens barrel in the first embodiment.

FIG. 8 is a conceptual view illustrating the optical operation of a virtual image display apparatus according to a variation.

FIG. 9 is a side cross-sectional view illustrating an internal structure of a virtual image display apparatus according to a second embodiment.

FIG. 10 is a partial cross-sectional view illustrating detailed structures of portions of the display optical system.

FIG. 11 is a conceptual view illustrating the optical operation of the virtual image display apparatus according to the second embodiment.

FIG. 12 is a conceptual view illustrating the optical operation of a virtual image display apparatus according to a variation.

### DESCRIPTION OF EMBODIMENTS

### First embodiment

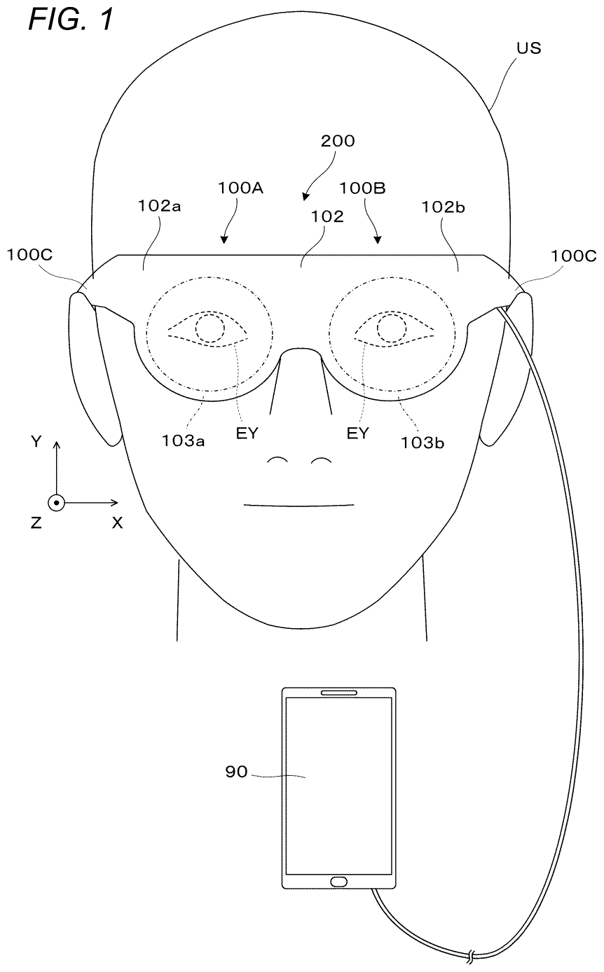

A virtual image display apparatus according to an embodiment of the present disclosure will be described below with reference to FIGS. 1 to 7.

FIG. 1 is a perspective view illustrating the state in which a head mounted display 200 is mounted. The head mounted display (hereinafter also referred to as HMD) 200 causes an observer or a wearer US, who wears the HMD 200, to recognize an image in the form of a virtual image. In FIG. 1 and other figures, X, Y, and Z form an orthogonal coordinate system, a +X direction corresponds to a lateral direction in which two eyes EY of the observer or the wearer US, who wears the HMD 200, are arranged, a +Y direction corresponds to an upward direction perpendicular to the lateral direction with respect to the wearer US, in which the two eyes EY are arranged, and a +Z direction corresponds to a forward direction or a frontward direction with respect to the wearer US. The ±Y directions are parallel to the vertical axis or the vertical direction.

The HMD 200 includes a first virtual image display apparatus 100A for the right eye, a second virtual image display apparatus 100B for the left eye, a pair of temples 100C, which support the virtual image display apparatuses 100A and 100B, and a user terminal 90, which is an information terminal. The first virtual image display apparatus 100A includes a first display driver 102a disposed in an upper portion of the display apparatus, and a first display optical system 103a, which covers the front of the eye. The second virtual image display apparatus 100B includes a second display driver 102b disposed in an upper portion of the display apparatus, and a second display optical system 103b, which covers the front of the eye. The HMD 200, which is the combination of the first virtual image display apparatus 100A and the second virtual image display apparatus 100B, is also a virtual image display apparatus in a broad sense. The pair of temples 100C support the upper ends of the pair of display optical systems 103a and 103b via the display drivers 102a and 102b integrated with each other in appearance. The combination of the pair of display drivers 102a and 102b is referred to as a drive apparatus 102.

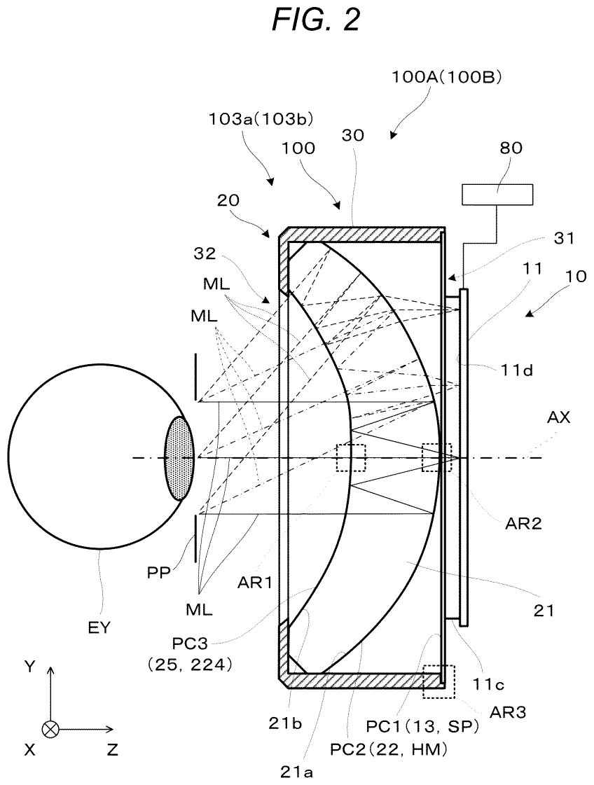

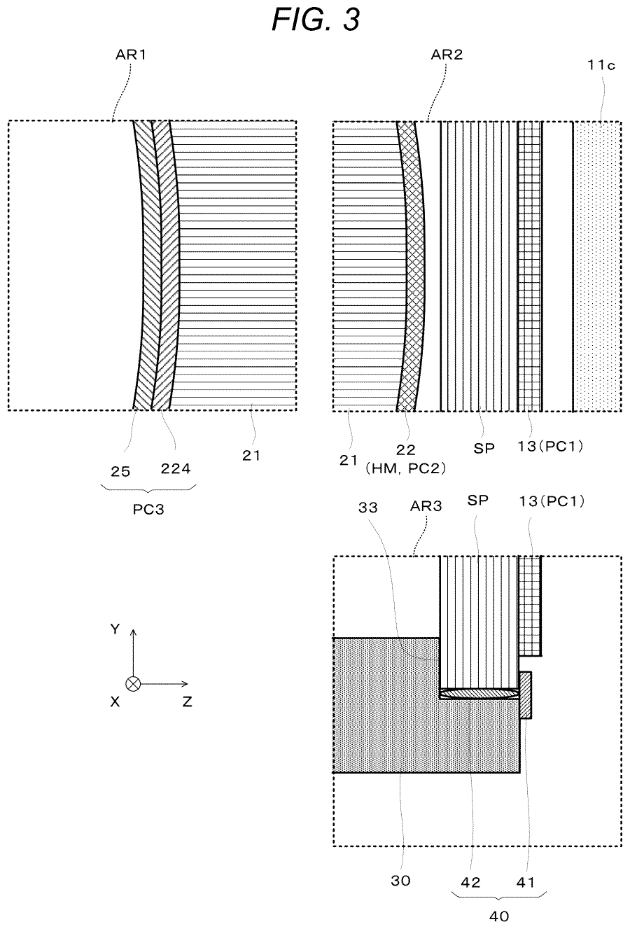

FIG. 2 is a conceptual side cross-sectional view illustrating the structure of the first display optical system 103a. FIG. 3 is a partial cross-sectional view illustrating detailed structures of portions of the first display optical system 103a. FIG. 3 has regions AR1, AR2, and AR3. The regions AR1, AR2, and AR3 in FIG. 3 show enlarged structures of regions AR1, AR2, and AR3 shown in FIG. 2, respectively. The first display optical system 103a includes a display 10, which outputs circularly polarized image light ML, an optical member 20, which reflects the image light ML twice to form a virtual image, and a circuit member 80, which controls the operation of the display 10 and the like.

Note that in the first virtual image display apparatus 100A, the optical apparatuses excluding the circuit member 80 (specifically, display 10 and optical member 20) are called an optical unit 100.

Although not described in detail, the second display optical system 103b is optically the same as the first display optical system 103a or a horizontally reversed version of the first display optical system 103a. In the following description, the first display optical system 103a will be described, but the second display optical system 103b will not be described.

In the first display optical system 103a, the display 10 includes an image display panel 11, which is a self-luminous image light generator, and a polarization control member PC1, which converts the image light ML output from the image display panel 11 into circularly polarized light. A cover glass plate 11c, which protects the image display panel 11, may be disposed between the image display panel 11 and the polarization control member PC1. The cover glass plate 11c and the polarization control member PC1 are separate from each other, as shown in the region AR2 of FIG. 3.

The image display panel 11 is, for example, an organic light emitting diode (OLED) display, and forms a monochrome or color still image or video images at a two-dimensional display surface 11d. The image light ML output from the image display panel 11 contains randomly polarized light. The image display panel 11 is driven by the circuit member 80 to perform a display operation. The image display panel 11 is not limited to an OLED display, and can instead be a display device using an inorganic EL element, an organic LED, an LED array, a laser array, a quantum dot luminous element, or the like.

The image display panel 11 is not limited to a self-luminous image light generator, and may be an element configured with a liquid crystal display (LCD) or any other light modulator and illuminated with light from a light source such as a background light to generate an image.

The polarization control member PC1 includes a circularly polarizing plate 13. As an example, the circularly polarizing plate 13 may be a thin film-shaped circularly polarizing element. The thickness of the film-shaped circularly polarizing element may be about 0.2 mm. As another example, the circularly polarizing plate 13 may be attached onto a transparent support plate SP and supported thereby.

The optical member 20 includes a polarization control member PC2, a lens member 21, and a polarization control member PC3 sequentially arranged from the side facing the image display panel 11. The lens member 21 is fixed inside a lens barrel 30. The optical member 20 is thus disposed inside the lens barrel 30.

The optical member 20 for image formation is configured with one lens and therefore has a very simple optical configuration. Since the optical member 20 can be configured with one lens, the number of parts is simply small, and no lens bonding process is necessary, so that the cost can be significantly reduced as compared with the configuration in the related art. The weight of the entire optical system can therefore be made very light.

In the optical member 20, the polarization control member PC2 includes a reflective optical element 22, as shown in the region AR2 in FIG. 3. The polarization control member PC3 includes a polarization conversion member 224 and a reflective polarization optical element 25 sequentially arranged from the side facing the lens member 21 in the −Z direction, as shown in the region AR1 of FIG. 3.

In the polarization control member PC2, the reflective optical element 22 is a transmissive mirror HM, which partially reflects the image light ML while partially transmitting the image light ML. The reflective optical element 22 covers a pupil position PP, at which the eyes EY or the pupil are located, is concave toward the pupil position PP, and is convex toward the outside. The reflectance of the reflective optical element 22 for the image light ML is set, for example, at about 50% from the viewpoint of ensuring the luminance of the image light ML, but is not limited thereto. The reflective optical element 22 is a monolayer film or a multilayer film made of metal such as Al or Ag and having an adjusted film thickness. The reflective optical element 22 can be formed, for example, by lamination using vapor deposition, and can instead be formed by attaching a sheet-shaped reflective film.

The lens member 21 is a pancake lens having convex and concave surfaces and having positive power, and has a light-incident-side first optical surface 21a and a light-exiting-side second optical surface 21b. The first optical surface 21a and the second optical surface 21b are each a curved surface, specifically, a spherical or aspherical surface. The lens member 21 is made, for example, of resin, and may instead be made of glass. The lens member 21 made of glass is advantageous from the viewpoint of size reduction. Note that the reflective optical element 22 is provided to face the first optical surface 21a, more specifically, is directly formed on the first optical surface 21a. That is, the first optical surface 21a and the reflective optical element 22 have the same shape, the first optical surface 21a functioning as a convex refractive surface, the reflective optical element 22 functioning as a concave reflective surface. The polarization optical element 25 is provided to face the second optical surface 21b, more specifically, is formed on the second optical surface 21b via the polarization conversion member 224, which is a thin-film-shaped member. That is, the second optical surface 21b and the polarization optical element 25 have the same shape, the second optical surface 21b functioning as a concave refractive surface, the polarization optical element 25 functioning as a convex reflective surface.

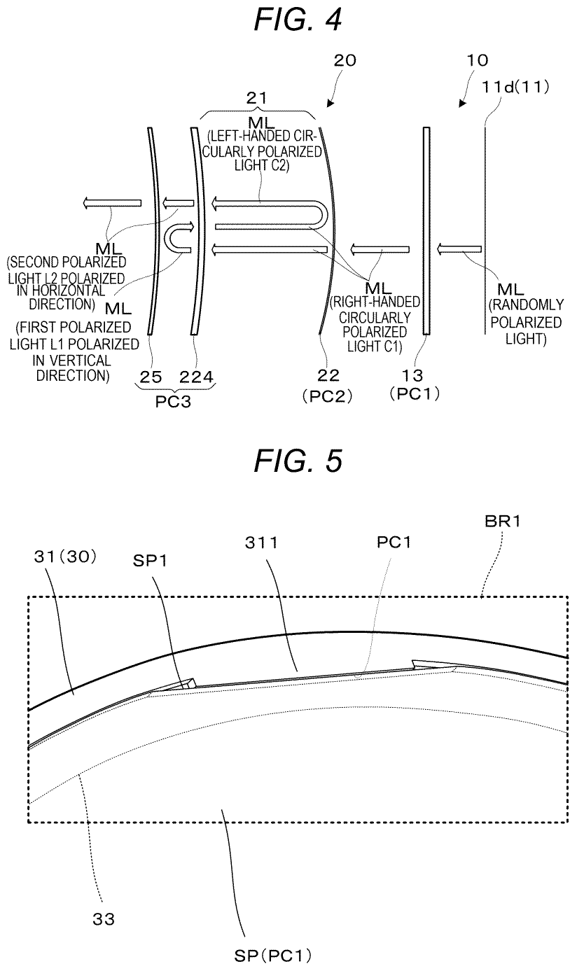

In the polarization control member PC3, the polarization conversion member 224 converts the circularly polarized light having passed through the lens member 21 into first linearly polarized light L1 polarized in a first polarization direction corresponding to the Y direction, which is a direction perpendicular to the traveling direction of the circularly polarized light, or the vertical direction (see FIG. 4). The polarization conversion member 224 is made, for example, of a liquid crystal material, for example, a photo-crosslinking polymer liquid crystal material. Another example of the material of the polarization conversion member 224 may be a film-shaped quarter waveplate.

Production of the polarization conversion member 224 will be briefly described. For example, a photo-crosslinking polymer liquid crystal material is applied onto a transparent resin substrate having flexibility to form a photo-crosslinking polymer liquid crystal material layer, that is, a thin film. Irradiating the thin film made of the photo-crosslinking polymer liquid crystal material with linearly polarized ultraviolet light having polarized in a controlled direction allows controlling the orientation state of liquid-crystallinity-expressing, rod-shaped molecular species (that is, molecules having difference in refractive index between major axis and minor axis) while curing the thin film made of the photo-crosslinking polymer liquid crystal material. In this process, out of the molecular species that provide liquid crystallinity when irradiated with ultraviolet light, molecular species extending in a direction that coincides with the polarization direction of the ultraviolet light crosslink, and the orientation state is fixed in the direction that is the same as the polarization direction. To this end, a concave lens or a container having a spherical surface is prepared, a photo-crosslinking polymer liquid crystal material is applied onto the surface of the concave lens or the container, and the photo-crosslinking polymer liquid crystal material is irradiated via an appropriate optical system with spherical-wave ultraviolet light the wave front of which has a curved plane having curvature equal to that of the surface, orientation state of the molecular species can be so fixed that the polarization direction extends along the surface. After the irradiation with the ultraviolet light, the thin film made of the photo-crosslinking polymer liquid crystal material is annealed. The liquid-crystallinity-expressing molecular species the alignment state of which has not changed by the ultraviolet light can thus be converted into liquid-crystal molecular species, and the orientation state thereof can be matched with the orientation state of a polymer portion having already had a target orientation state, followed by cooling to fix the orientation state. That is, a waveplate configured with a thin film in which most of the liquid-crystallinity-expressing molecular species that constitute the photo-crosslinking polymer liquid crystal material have the same orientation direction is produced. The retardation provided by the thus produced waveplate can be adjusted by adjusting the thickness thereof. The thus produced polarization conversion member 224 is attached to the second optical surface 21b, for example, with an adhesive, so that the polarization conversion member 224 is fixed to the lens member 21. In the above description, the polarization conversion member 224 is formed by applying the photo-crosslinking polymer liquid crystal material onto the transparent resin substrate, and the polarization conversion member 224 may instead be directly attached to the optical surfaces 21a and 21b of the lens member 21.

A liquid crystal optical body such as the polarization conversion member 224 can be produced also by a method for manufacturing a liquid crystal optical body described in JP-T-2008-501147. A liquid crystal optical body such as the polarization conversion member 224 can be produced also by the method described in https://www.jstage.jst.go.jp/article/oubutsu1932/70/9/70_9_1078/_pdf.

The polarization optical element 25 is a wire-grid polarizer, selectively reflects the first linearly polarized light L1 polarized in the first polarization direction corresponding to the Y direction, which is a direction perpendicular to the traveling direction of the first linearly polarized light L1, or the vertical direction, and selectively transmits only second linearly polarized light L2 polarized in a second polarization direction corresponding to the X direction, which is the horizontal direction (see FIG. 4). The polarization optical element 25 has, for example, a structure in which a large number of metal thin wires made of aluminum, nickel, or the like are arranged in parallel to each other on a transparent resin substrate having flexibility, and a wire grid layer configured with the large number of metal thin wires is covered with a transparent protective layer. The polarization optical element 25 reflects linearly polarized light having an electric field component (corresponding to polarization direction) parallel to the direction in which the large number of thin metal wires extend and perpendicular to the periodic direction corresponding to the direction in which the large number of thin metal wires are arranged. The body of the polarization optical element 25 is produced by transferring convex and concave shapes to the surfaces of a resin film made of UV resin or thermoplastic resin using a die having the convex and concave structure, and then depositing aluminum in an oblique direction onto the top and side surfaces of the convex portion of the convex and concave shapes using vacuum deposition. The body of the polarization optical element 25 can be produced also by applying a polymer solution onto a die having a convex and concave structure using spin coating and curing the polymer solution formed at the surfaces of the die (see JP-A-2011-221334, for example). The thus produced polarization optical element 25 is attached to the polarization conversion member 224, for example, with an adhesive, so that the polarization optical element 25 is fixed to the lens member 21.

The polarization optical element 25 may not be a wire-grid polarizer, and may, for example, be a polarizer of a type in which multiple films having anisotropy and produced by rolling are laminated on each other.

The optical operation of the virtual image display apparatus 100A according to the first embodiment will be described with reference to FIGS. 2, 3, and 4. First, the display 10 outputs the image light ML, and the image light ML enters the polarization control member PC1, as shown in FIG. 2. The image light ML is incident on and passes through a central portion of a sealing member including the polarization control member PC1, the central portion where the circularly polarizing plate 13 is disposed, other than a circumferential edge portion in contact with and fixed to a first opening (see region AR3 of FIG. 3). At this point in time, the image light ML output from the display 10 passes through the polarization control member PC1, which converts the image light ML into right-handed circularly polarized light C1, as shown in FIG. 4. The image light ML formed of the right-handed circularly polarized light C1 and having entered the optical member 20 from the display 10 partially passes through the reflective optical element 22, and the intensity of the image light ML is attenuated by a factor of about two when passing through the reflective optical element 22. The image light ML having passed through the reflective optical element 22 passes through the lens member 21 and passes through the polarization conversion member 224. In this process, the image light ML is refracted by the lens member 21, the positive power of which causes the image light ML to relatively converge. The image light ML passes through the polarization conversion member 224 in the forward direction, which converts the image light ML formed of the right-handed circularly polarized light C1 into the image light ML formed of the first linearly polarized light L1 polarized in the first polarization direction, which enters the polarization optical element 25. The image light ML having entered the polarization optical element 25 is efficiently reflected as the first linearly polarized light L1 off the polarization optical element 25. When passing through the lens member 21, the image light ML is converted into the right-handed circularly polarized light C1 when passing through the polarization conversion member 224 in the opposite direction. The image light ML output from the lens member 21 is reflected off the reflective optical element 22, and the positive power of the lens member 21 causes the image light ML to relatively converge, the intensity of the image light ML attenuated by a factor of about two when reflected off the reflective optical element 22. In this process, the image light ML formed of the right-handed circularly polarized light C1 is converted into the image light ML formed of left-handed circularly polarized light C2. The image light ML formed of the left-handed circularly polarized light C2 and reflected off the reflective optical element 22, when passing through the lens member 21, passes through the polarization conversion member 224 in the forward direction, which converts the image light ML into the second linearly polarized light L2 polarized in the second polarization direction, which enters the polarization optical element 25. In the operation described above, the image light ML is reflected off the reflective optical element 22 and therefore travels back and forth in the lens member 21, passes through the lens member 21 twice during the back-and-forth travel. As a result, the image light ML passes through the lens member 21 three times. The image light ML having entered the polarization optical element 25 via the lens member 21 efficiently passes through the polarization optical element 25 as the second linearly polarized light L2 polarized in the second polarization direction. The image light ML having exited out of the optical member 20 is incident on the pupil position PP, at which the eyes EY of the wearer US are located, with the image light ML collimated by the converging effect of the optical member 20 (see FIG. 2). That is, the wearer US who wears the first virtual image display apparatus 100A can observe a virtual image formed by the image light ML.

In the display optical systems 103a and 103b shown in FIG. 2, since the second optical surface 21b is a concave surface, the beam of the image light ML output from the image display panel 11 can be tilted inward, that is, toward an optical axis AX, and the material of the lens member 21 can therefore have a margin in terms of the total reflection angle, so that the lens curvature can be increased, and the image display panel 11 and the entire optical system can hence be reduced in size. Furthermore, when the ratio between curvature R1 of the first optical surface 21a and curvature R2 of the second optical surface 21b satisfies the following expression:

0.5≤R1/R2≤1.5
the beam of the image light ML output from the image display panel 11 can be made substantially parallel to the direction of a normal to the panel (direction parallel to optical axis AX). As a result, regarding the image viewed by a user through the display optical systems 103a and 103b, a virtual image that is a displayed image can be visually recognized without luminance or color unevenness because the image light ML output in the direction of a normal to the panel enters the eyes EY. In particular, the curvature R2 of the second optical surface 21b preferably ranges from 5 mm to 30 mm.

Note that the first polarization direction and the second polarization direction are defined for convenience, and the definitions of specific directions can be swapped. That is, in the example shown in FIG. 4, the polarization optical element 25 reflects the first linearly polarized light L1 polarized in the first polarization direction that is the Y direction, and the polarization optical element 25 may instead reflect the first linearly polarized light L1 polarized in the first polarization direction that is the X direction. In this case, the direction of the principal axis of the polarization conversion member 224 is adjusted to adapt to the polarization optical element 25.

A configuration in which the first opening 31 of the lens barrel 30, via which the image light ML from the image display panel 11 passes, is sealed will be described with reference to FIGS. 2, 3, and 5. The lens member 21 seals a second opening 32 of the lens barrel 30, via which the image light ML exits, as shown in FIG. 2. The polarization control member PC1 is also used as a sealing member that seals the first opening 31 of the lens barrel 30, which incorporates the lens member 21, the first opening 31 being an opening through which the image light ML passes. The sealing member may include the circularly polarizing plate 13 and the support plate SP.

An end portion of the support plate SP, which is part of the polarization control member PC1 as the sealing member, is held by a first holder 33 provided at the inner side surface of the first opening 31 of the lens barrel 30, as shown in the region AR3 of FIG. 3. The end portion of the support plate SP functions as the circumferential edge portion of the sealing member that is the portion fixed to the first opening 31. The first holder 33 and the end portion of the support plate SP may be bonded to each other with a first adhesive 42. The gap between the first holder 33 and the end portion of the support plate SP is sealed by the first adhesive 42 and a tape 41, which serve as a dustproof member 40, so that the airtightness at the first opening 31 of the lens barrel 30 is enhanced to ensure a dust-free lens barrel 30. The tape 41 may be disposed over the ring-shaped gap between the polarization control member PC1 and the first opening 31 to reliably prevent dust from entering the gap and temporarily fix the polarization control member PC1 to the first opening 31.

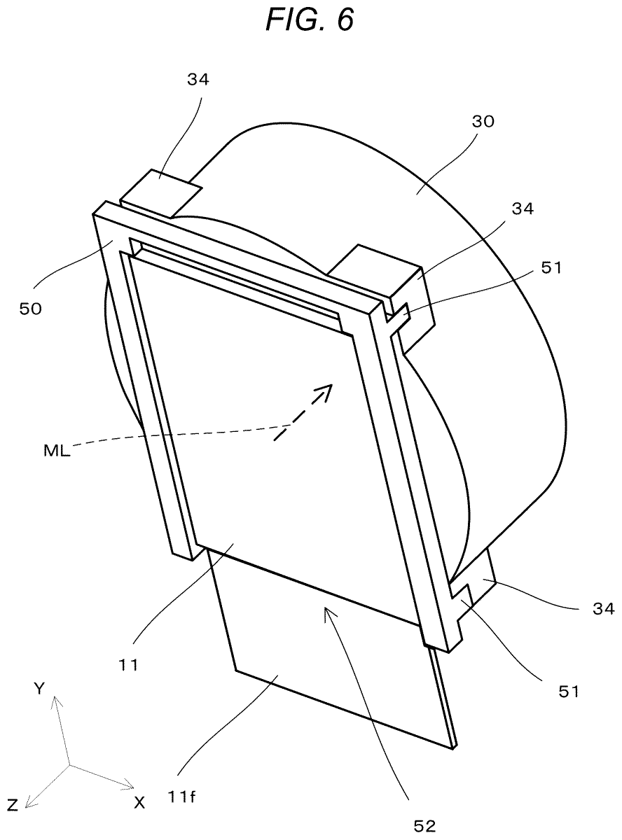

Before fixing the position of the polarization control member PC1 as the sealing member with respect to the lens barrel 30 through adhesion using the first adhesive 42, the position of the polarization control member PC1 with respect to the lens barrel 30 is adjusted. This position adjustment is primarily performed by rotating the polarization control member PC1 in an XY plane perpendicular to the optical axis AX. The range of the position adjustment may be minimized by providing a mechanism that limits the angle by which the polarization control member PC1 as the sealing member rotates in the XY plane, as shown in a region BR1 of FIG. 5. The region BR1 shows portions of the lens barrel 30 and the polarization control member PC1. The mechanism may include a notch 311 provided at the inner side surface of the first opening 31 of the lens barrel 30, and a cutout SP1 provided at the outer side surface of the support plate SP of the polarization control member PC1. As an example, the range of the angle by which the polarization control member PC1 rotates in the XY plane may be about ±10 degrees.

To prevent foreign matter from entering the lens barrel 30 when the position of the polarization control member PC1 with respect to the first opening 31 is adjusted, the gap between the polarization control member PC1 and the first holder 33 is sealed with the first adhesive 42 and the tape 41 before the position adjustment is initiated. The tape 41 has sufficient elasticity so as not to hinder the movement and/or rotation of the polarization control member PC1 with respect to the first opening 31 that accompanies the position adjustment, and the first adhesive 42 is curable at any timing after the position adjustment is completed, and is, for example, a UV curable adhesive. More specifically, the first adhesive 42 has sufficient fluidity before cured, and the position and direction of the polarization control member PC1 with respect to the lens barrel 30 can be adjusted in a state in which the first adhesive 42 before cured is applied into the space between the first holder 33 of the first opening 31 and the circumferential edge of the support plate SP. Furthermore, the first adhesive 42 has sufficient hardness after cured, and fixes the position and direction of the polarization control member PC1 with respect to the lens barrel 30 even when stress resulting from the elasticity of the tape 41 remains. To allow UV light that cures the UV-curable first adhesive 42 to reach the first adhesive 42, the tape 41 has sufficient transmittance at least for the UV light. As an example, the tape 41 may be an acrylic, baseless adhesive tape having elasticity. Note, however, that the tape 41 and the first adhesive 42 are merely examples and do not limit the present embodiment.

The same holds true for the second opening 32. That is, after the position of the lens member 21 with respect to the lens barrel 30 is adjusted in a state in which the UV-curable adhesive is applied into the gap between the lens barrel 30 and the end of the lens member 21, the adhesive may be irradiated with UV light through the second opening 32 or the first opening 31 to cure the adhesive. As a result, the lens member 21 can be fixed to the lens barrel 30, and the second opening 32 can be sealed. Note that when the lens member 21 is inserted into the lens barrel 30 through the first opening 31, the first opening 31 is sealed afterward.

Sealing the first opening 31 and the second opening 32 of the lens barrel 30 as described above can prevent foreign matter that may be present inside the lens barrel 30 from leaking out of the lens barrel 30, and can also prevent foreign matter that may be present outside the lens barrel 30 from entering the lens barrel 30. Examples of such foreign matter may include dust derived, for example, from a portion of the first adhesive 42, a portion of the tape 41, sebum of an operator who touches any of the elements at the time of assembly.

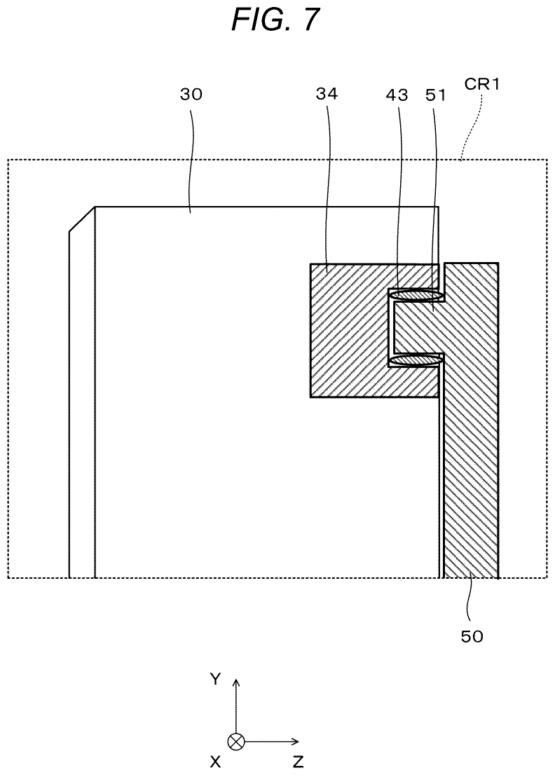

Adjustment of the position of the image display panel 11 with respect to the lens barrel 30 and fixation of the image display panel 11 to the lens barrel 30 by using a support frame 50 will be described with reference to FIGS. 6 and 7. The support frame 50 supports the image display panel 11, as shown in FIG. 6. The support frame 50 includes a protrusion 51 protruding in the −Z direction, in which the image display panel 11 outputs the image light ML, and is fixed to a second holder 34, which is provided at the outer side surface of the lens barrel 30 via the protrusion 51, with a second adhesive 43 (see FIG. 7). A flexible printed circuit (FPC) portion 11f, which transmits a control signal from the circuit member 80 to the image display panel 11, is coupled to the image display panel 11, and the support frame 50 is provided with a gap 52, through which the FPC portion 11f passes without interference with the support frame 50.

The protrusion 51 of the support frame 50 is held by the second holder 34 provided at the outer side surface of the first opening 31 of the lens barrel 30, as shown in a region CR1 of FIG. 7. The protrusion 51 of the support frame 50 and the second holder 34 of the lens barrel 30 may be configured with multiple protrusions 51 and multiple second holders 34, respectively. The protrusions 51 are fixed to the respective second holders 34 with the second adhesive 43. Note that the region CR1 of FIG. 7 shows a cross section of the second holder 34 and the protrusion 51 involved in the fixation using the second adhesive 43 out of the second holder 34 of the lens barrel 30 and the protrusions 51 of the support frame 50.

The second adhesive 43 may be curable at any timing after the position of the support frame 50 with respect to the lens barrel 30 is adjusted, and may, for example, be a UV curable adhesive as the first adhesive 42 shown in the region AR3 of FIG. 3. That is, after the position of the support frame 50 with respect to the lens barrel 30 is adjusted in a state in which the second adhesive 43 before cured is applied into the space between the second holders 34 of the lens barrel 30 and the protrusions 51 of the support frame 50, the support frame 50 is fixed to the lens barrel 30 by curing the second adhesive 43 at any timing. The adjustment of the position of the support frame 50 with respect to the lens barrel 30 may include rotation around the Z-axis. As an example, the range of rotation around the Z-axis in the position adjustment may be about one degree. The adjustment of the position of the support frame 50 with respect to the lens barrel 30 may include movement parallel to each of the X-axis, the Y-axis, and the Z-axis.

The adjustment of the position of the support frame 50 with respect to the lens barrel 30 as described above allows the adjustment of the position of the image display panel 11 fixed to the support frame 50 with respect to the lens barrel 30.

### Variations

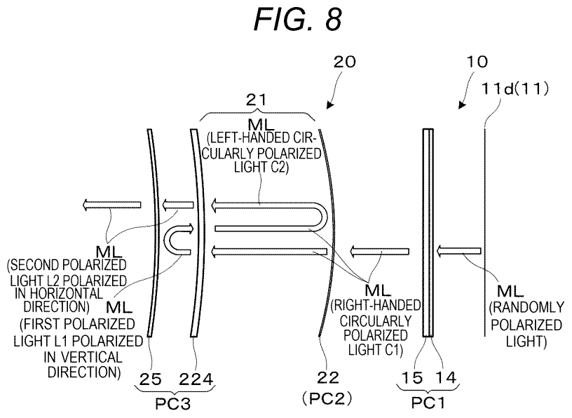

In the embodiment described above, the configuration in which the image display panel 11 is an OLED or the like and the polarization control member PC1 includes the circularly polarizing plate 13 has been described. As a variation of the configuration described above, a configuration in which the polarization control member PC1 includes a linearly polarizing plate 14 and a quarter waveplate 15 will be described, as shown in FIG. 8. In the configuration described above, the image display panel 11 is not limited to a self-luminous image light generator, and may be an element configured with a liquid crystal display (LCD) or any other light modulator and illuminated with light from a light source such as a background light to generate an image.

The polarization control member PC1 includes the linearly polarizing plate 14 and the quarter waveplate 15 sequentially arranged from the side facing the image display panel 11.

The linearly polarizing plate 14 is, for example, an absorptive polarizing plate, and selectively transmits, in the present embodiment, only the second linearly polarized light (horizontally polarized light) polarized in the X direction, which is the horizontal direction. That is, only the linearly polarized light polarized in the X direction out of the image light ML output from the image display panel 11 passes through the linearly polarizing plate 14 and enters the quarter waveplate 15. The linearly polarizing plate 14 is a sheet-shaped element, and is produced by stretching, in a fixed direction, a film in which polyvinyl alcohol (PVA) is impregnated with a dichroic dye such as iodine.

The principal axis or fast axis of the quarter waveplate 15 is set between the vertical direction and the horizontal direction, that is, between the Y direction and the X direction, and the quarter waveplate 15 converts the second linearly polarized light (horizontally polarized light) having passed through the linearly polarizing plate 14 into, for example, the right-handed circularly polarized light C1. As an example, the quarter waveplate 15 may be a film-shaped retardation plate produced by rolling a polymer material. A specific method for generating a film-shaped retardation plate may include rolling two polymer materials in such a way that a density difference and/or a refractive index difference is created in a rolling direction and/or the direction in which the two polymer materials face each other. As another example, the quarter waveplate 15, which is made of a liquid crystal material such as a photo-crosslinking polymer liquid crystal material in the above description, may instead be formed by processing a birefringent crystal material such as quartz crystal into a thin plate. As a specific production method, the linearly polarizing plate 14 is provided on the cover glass plate 11c of the image display panel 11, and the quarter waveplate 15 made of a UV-curable photo-crosslinking polymer liquid crystal material is provided on the linearly polarizing plate 14. The photo-crosslinking polymer liquid crystal material is applied onto the cover glass plate 11c, for example, in a spin coating or inkjet process while the film thickness of the quarter waveplate 15 is controlled, then irradiated with polarized ultraviolet light, and then baked so as to function as the quarter waveplate 15.

The virtual image display apparatuses 100A and 100B and the optical unit 100 according to the first embodiment described above each include the lens barrel 30 having the first opening 31, through which the image light ML passes, the lens member 21 as a first lens fixed inside the lens barrel 30, the polarization control member PC1 and the support plate SP as the sealing member fixed to the first opening 31 and sealing the first opening 31, and the image display panel 11 fixed outside the lens barrel 30 and generating the image light ML to be output toward the first lens via the sealing member, and the sealing member includes the polarization control member PC1, which converts the image light ML into predetermined polarized light.

In each of the virtual image display apparatuses 100A and 100B and the optical unit 100 described above, the lens member 21 is incorporated in the lens barrel 30, and the first opening 31 and the second opening 32 of the lens barrel 30 are sealed by the polarization control member PC1 and the lens member 21, respectively. As a result, entry of foreign matter from the exterior of the lens barrel 30 into the interior thereof, and leakage of foreign matter from the interior of the lens barrel 30 to the exterior thereof can be prevented, so that deterioration of image quality due to foreign matter captured in an image formed by the image light ML output by the image display panel 11 provided outside the lens barrel 30 can be suppressed. Furthermore, in the virtual image display apparatuses 100A and 100B and the optical unit 100 described above, the amount of rotation of the image display panel 11 with respect to the lens barrel 30 for purposes of adjustment of the optical axis of the optical system, defocusing, and the like can be minimized, as compared with a configuration in which the circularly polarizing plate 13, the quarter waveplate 15, and the like of the polarization control member PC1 are attached to the surface of the image display panel 11 or the cover glass plate 11c of the display 10 instead of the first opening 31 of the lens barrel 30. The virtual image display apparatuses 100A and 100B and the optical unit 100 described above therefore also provide an excellent effect of reducing the sizes of the lens barrel 30 and the support frame 50.

### Second Embodiment

In the first embodiment described above, the virtual image display apparatuses 100A and 100B and the optical unit 100 have been described with reference to the case where the lens member 21 is configured with a single lens having convex and concave surfaces. In a second embodiment, the virtual image display apparatuses 100A and 100B and the optical unit 100 will be described with reference to a case where the lens member 21 is configured with a plano-convex lens and a plano-concave lens. Out of the elements that constitute the virtual image display apparatuses 100A and 100B and the optical unit 100 according to the second embodiment, elements common to those in the first embodiment excluding the lens member 21 will not be described in detail.

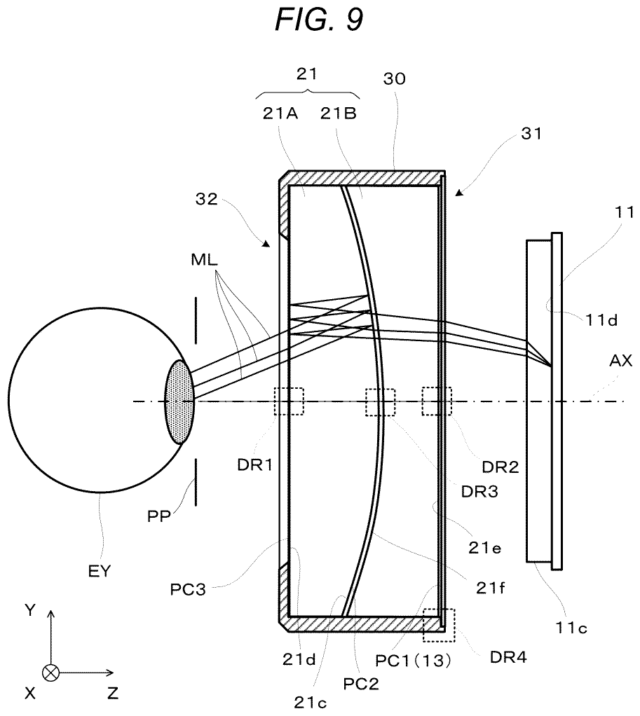

The lens member 21 according to the second embodiment includes a first lens 21A and a second lens 21B, as shown in FIG. 9. The first lens 21A is a plano-convex lens having a convex third optical surface 21c and a planar fourth optical surface 21d. The second lens 21B is a plano-concave lens having a planar fifth optical surface 21e and a concave sixth optical surface 21f. The second lens 21B and the first lens 21A are arranged inside the lens barrel 30 in this order from the side facing the image display panel 11 in the −Z direction. The fifth optical surface 21e of the second lens 21B faces the polarization control member PC1 as the sealing member fixed to the first opening 31 of the lens barrel 30, and the fourth optical surface 21d of the first lens 21A faces the second opening 32 of the lens barrel 30. The sixth optical surface 21f of the second lens 21B and the third optical surface 21c of the first lens 21A face each other. The sixth optical surface 21f of the second lens 21B and the third optical surface 21c of the first lens 21A have shapes complementary to each other, and are spherical or aspherical surfaces having rotational symmetry around the optical axis AX.

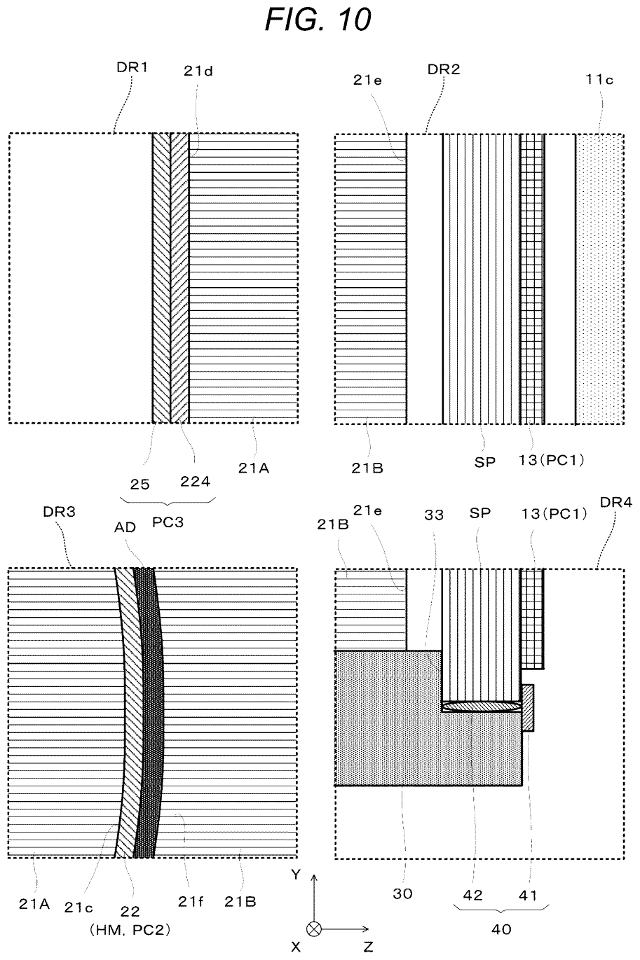

FIG. 10 has regions DR1, DR2, DR3, and DR4. The regions DR1, DR2, DR3, and DR4 in FIG. 10 show enlarged structures of regions DR1, DR2, DR3, and DR4 shown in FIG. 9, respectively. The cover glass plate 11c and the polarization control member PC1 are separate from each other, as shown in the region DR2 of FIG. 10. The support plate SP and the fifth optical surface 21e of the second lens 21B are separate from each other. An end portion of the support plate SP as a portion of the polarization control member PC1 as the sealing member is held by the first holder 33 provided at the inner side surface of the first opening 31 of the lens barrel 30, as shown in the region DR4 of FIG. 10. The first holder 33 and the end portion of the support plate SP may be bonded to each other with the first adhesive 42. The gap between the first holder 33 and the end portion of the support plate SP is sealed by the first adhesive 42 and the tape 41, which serve as the dustproof member 40, so that the airtightness at the first opening 31 of the lens barrel 30 is enhanced. The tape 41 may be disposed over the ring-shaped gap between the polarization control member PC1 and the first opening 31. The polarization control member PC2 is formed on the third optical surface 21c of the first lens 21A, as shown in the region DR3 of FIG. 10. The polarization control member PC2 includes the reflective optical element 22, and the reflective optical element 22 is the transmissive mirror HM. The sixth optical surface 21f of the second lens 21B and the third optical surface 21c of the first lens 21A are bonded to each other by an adhesive film AD. Note, however, that the polarization control member PC2 is formed between the sixth optical surface 21f of the second lens 21B and the adhesive film AD. The polarization control member PC3 is provided on the fourth optical surface 21d of the first lens 21A, as shown in the region DR1 of FIG. 10. The polarization control member PC3 includes the polarization conversion member 224 and the reflective polarization optical element 25 sequentially arranged from the side facing the first lens 21A in the −Z direction.

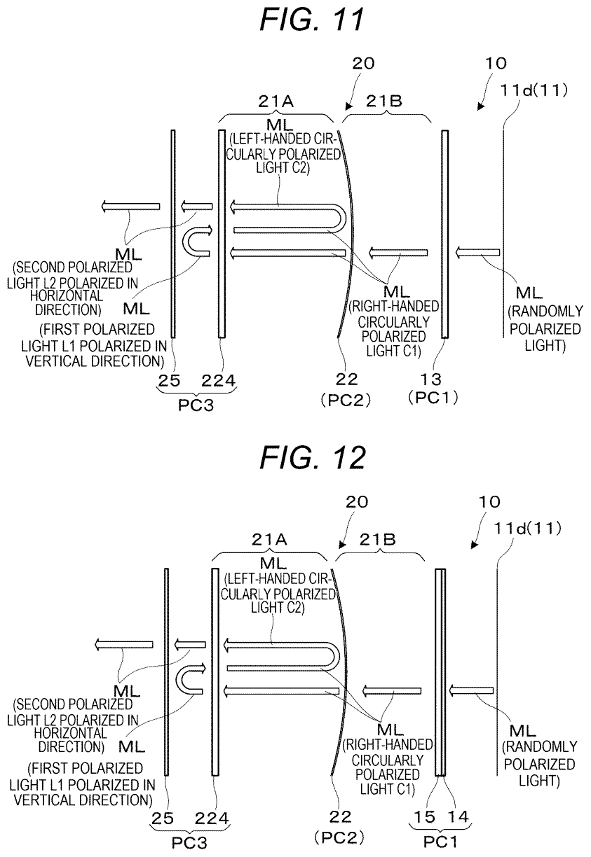

The optical operation of the virtual image display apparatus 100A according to the second embodiment will be described with reference to FIG. 11. The image light ML output from the display 10 passes through the polarization control member PC1 and becomes the right-handed circularly polarized light C1, as shown in FIG. 11. When the image light ML having passed through the polarization control member PC1 passes through the second lens 21B, the image light ML is refracted by the second lens 21B, which is a plano-concave lens, the negative power of which causes the image light ML to relatively diverge. The image light ML formed of the right-handed circularly polarized light C1 and having passed through the second lens 21B and entered the optical member 20 partially passes through the reflective optical element 22, the intensity of the image light ML attenuated by a factor of about two when passing through the reflective optical element 22. The image light ML having passed through the reflective optical element 22 passes through the first lens 21A and passes through the polarization conversion member 224. The image light ML passes through the polarization conversion member 224 in the forward direction, which converts the image light ML formed of the right-handed circularly polarized light C1 into the image light ML formed of the first linearly polarized light L1 polarized in the first polarization direction, which enters the polarization optical element 25. The image light ML having entered the polarization optical element 25 is efficiently reflected as the first linearly polarized light L1 off the polarization optical element 25. When passing through the first lens 21A, the image light ML is converted into the right-handed circularly polarized light C1 when passing through the polarization conversion member 224 in the opposite direction. The image light ML output from the first lens 21A is reflected off the reflective optical element 22, and the positive power of the first lens 21A causes the image light ML to relatively converge, the intensity of the image light ML attenuated by a factor of about two when reflected off the reflective optical element 22. In this process, the image light ML formed of the right-handed circularly polarized light C1 is converted into the image light ML formed of the left-handed circularly polarized light C2. The image light ML formed of the left-handed circularly polarized light C2 and reflected off the reflective optical element 22, when passing through the first lens 21A, passes through the polarization conversion member 224 in the forward direction, which converts the image light ML into the second linearly polarized light L2 polarized in the second polarization direction, which enters the polarization optical element 25. In the operation described above, the image light ML is reflected off the reflective optical element 22 and therefore travels back and forth in the first lens 21A, passes through the first lens 21A twice during the back-and-forth travel. As a result, the image light ML passes through the first lens 21A three times. The image light ML having entered the polarization optical element 25 via the first lens 21A efficiently passes through the polarization optical element 25 as the second linearly polarized light L2 polarized in the second polarization direction. The image light ML having exited out of the optical member 20 is incident on the pupil position PP, at which the eyes EY of the wearer US are located, with the image light ML collimated by the converging effect of the optical member 20 (see FIG. 9). That is, the wearer US who wears the first virtual image display apparatus 100A can observe a virtual image formed by the image light ML.

### Variations

Also in the present embodiment, the polarization control member PC1 may include the linearly polarizing plate 14 and the quarter waveplate 15, as shown in FIG. 12, as in the first embodiment. In this case, the image display panel 11 may be an element configured with a liquid crystal display (LCD) or any other light modulator and illuminated with light from a light source such as a background light to generate an image.

In the virtual image display apparatuses 100A and 100B and the optical unit 100 according to the second embodiment described above, the first lens 21A includes a plano-convex lens having a convex surface as the third optical surface 21c and a planar surface as the fourth optical surface 21d, and the virtual image display apparatuses 100A and 100B and the optical unit 100 each further include the second lens 21B as a plano-concave lens having a concave surface as the sixth optical surface 21f facing the third optical surface 21c and a planar surface as the fifth optical surface 21e facing the first opening 31.

In the virtual image display apparatuses 100A and 100B and the optical unit 100 according to the first embodiment described above, since the polarization control member PC1 faces the convex surface of the lens member 21 that is a surface having relatively strong curvature, the polarizing plate that is a portion of the polarization control member PC1 provides a lens effect, so that the resolution of the optical system deteriorates in some cases. In contrast, in the virtual image display apparatuses 100A and 100B and the optical unit 100 according to the second embodiment described above, since the polarization control member PC1 faces the planar surface of the second lens 21B, which is a plano-concave lens, the lens effect provided by the polarizing plate is smaller than that in the first embodiment, so that the deterioration of the resolution of the optical system due to the lens effect can be suppressed.

A virtual image display apparatus according to a specific aspect includes a lens barrel having a first opening through which image light passes; a first lens fixed inside the lens barrel; a sealing member fixed to the first opening and configured to seal the first opening; and an image display panel fixed outside the lens barrel and configured to generate the image light to be output toward the first lens via the sealing member, and the sealing member includes a polarization control member configured to convert the image light into predetermined polarized light.

In the virtual image display apparatus according to the specific aspect, the sealing member has a circumferential edge portion fixed to the first opening, and a central portion where the polarization control member is disposed and through which the image light passes.

In the virtual image display apparatus according to the specific aspect, the sealing member further includes a support plate configured to support the polarization control member, and the first opening is provided with a first holder configured to hold an end portion of the support plate.

The virtual image display apparatus according to the specific aspect further includes a dustproof member configured to fix the sealing member to the lens barrel while reliably preventing dust from entering the first opening of the lens barrel.

In the virtual image display apparatus described above, the lens member is incorporated in the lens barrel, and the first opening of the lens barrel is sealed by the polarization control member. As a result, entry of foreign matter from the exterior of the lens barrel into the interior thereof, and leakage of foreign matter from the interior of the lens barrel to the exterior thereof can be prevented, so that deterioration of image quality due to foreign matter captured in an image formed by the image light output by the image display panel provided outside the lens barrel can be suppressed.

In the virtual image display apparatus according to the specific aspect, the dustproof member includes a tape having elasticity and configured to temporarily fix the sealing member to the first opening of the lens barrel while reliably preventing dust from entering the first opening of the lens barrel, and a first adhesive having fluidity that allows, before cured, adjustment of a position and a direction of the polarization control member with respect to the lens barrel and fixes, after cured, the position and the direction of the polarization control member with respect to the lens barrel.

The virtual image display apparatus according to the specific aspect further includes a support frame configured to support the image display panel, the lens barrel further includes a second holder configured to hold the support frame, and the virtual image display apparatus further includes a second adhesive that is curable at any timing and fixes the support frame to the second holder of the lens barrel in a state in which a position and a direction of the image display panel with respect to the lens barrel are adjusted.

In the virtual image display apparatus described above, using the tape having elasticity and the adhesive being curable at any timing as the dustproof member allows the polarization control member and the image display panel to be fixed to the lens barrel after the positions of the polarization control member and the image display panel with respect to the lens barrel are adjusted.

In the virtual image display apparatus according to the specific aspect, the lens barrel further includes a second opening through which the image light passing through the first lens exits, and the first lens is configured to seal the second opening.

In the virtual image display apparatus described above, the first lens seals the second opening of the lens barrel. As a result, entry of foreign matter from the exterior of the lens barrel into the interior thereof, and leakage of foreign matter from the interior of the lens barrel to the exterior thereof can be prevented, so that deterioration of image quality due to foreign matter captured in an image formed by the image light output by the image display panel provided outside the lens barrel can be suppressed.

In the virtual image display apparatus according to the specific aspect, the polarization control member is configured to convert the image light from the image display panel into circularly polarized light, a half-silvered mirror is provided at a first optical surface of the first lens that is a surface facing the first opening, a polarization conversion member configured to convert linearly polarized light into circularly polarized light and convert circularly polarized light into linearly polarized light is provided at a second optical surface of the first lens that is a surface facing the second opening, and a polarization optical element configured to reflect first linearly polarized light and transmit second linearly polarized light is provided on an outer side of the polarization conversion member at the second optical surface.

In the virtual image display apparatus according to the specific aspect, the first lens includes a pancake lens having a convex surface as the first optical surface and a concave surface as the second optical surface.

The virtual image display apparatus described above, in which the image light is reflected between the optical surfaces of the pancake lens while the polarization of the image light is changed and then the image light is delivered to the eyes of the wearer, can be a smaller, lighter virtual image display apparatus.

In the virtual image display apparatus according to the specific aspect, the first lens includes a plano-convex lens having a convex surface as the first optical surface and a planar surface as the second optical surface, and the virtual image display apparatus further includes a second lens as a plano-concave lens having a concave surface as a third optical surface facing the first optical surface, and a planar surface as a fourth optical surface facing the first opening.

In the virtual image display apparatus described above, using the second lens, which has a planar optical surface facing the polarization control member, allows suppression of deterioration of the resolution of the optical system due to the lens effect provided by the space between the polarization control member and the lens facing the polarization control member.

In the virtual image display apparatus according to the specific aspect, the image display panel includes an OLED panel configured to generate the image light, and the polarization control member includes a circularly polarizing element configured to convert the image light from the image display panel into circularly polarized light.

In the virtual image display apparatus according to the specific aspect, the image display panel includes a liquid crystal panel configured to generate the image light, and the polarization control member includes a polarizing plate configured to extract a predetermined linearly polarized component of the image light from the image display panel, and a quarter waveplate configured to convert the linearly polarized light into circularly polarized light.

The virtual image display apparatus described above can employ the OLED panel and the liquid crystal panel as the image display panel.

An optical unit according to a specific aspect includes a lens barrel having a first opening through which image light passes; a first lens fixed inside the lens barrel; a sealing member fixed to the first opening and configured to seal the first opening; and an image display panel fixed outside the lens barrel and configured to generate the image light to be output toward the first lens via the sealing member, the sealing member including a polarization control member configured to convert the image light into predetermined polarized light.

In the optical unit described above, the lens member is incorporated in the lens barrel, and the first opening of the lens barrel is sealed by the polarization control member. As a result, entry of foreign matter from the exterior of the lens barrel into the interior thereof, and leakage of foreign matter from the interior of the lens barrel to the exterior thereof can be prevented, so that deterioration of image quality due to foreign matter captured in an image formed by the image light output by the image display panel provided outside the lens barrel can be suppressed.

The disclosure made by the present discloser has been specifically described based on the embodiments. The present disclosure is not limited to the embodiments, and it goes without saying that various changes can be made thereto without departing from the key points of the present disclosure. In addition, the features described in the embodiments can be freely combined with each other as long as the combined features do not technically contradict each other.

What is claimed is:

1. A virtual image display apparatus, comprising:
a lens barrel having a first opening through which image light passes;
a first lens fixed inside the lens barrel;
a sealing member fixed to the first opening and configured to seal the first opening; and
an image display panel fixed outside the lens barrel and configured to generate the image light to be output toward the first lens via the sealing member,
wherein the sealing member includes a polarization control member configured to convert the image light into predetermined polarized light.

2. The virtual image display apparatus according to claim 1, wherein
the sealing member has
a circumferential edge portion fixed to the first opening, and
a central portion where the polarization control member is disposed and through which the image light passes.

3. The virtual image display apparatus according to claim 1, wherein
the sealing member further includes a support plate configured to support the polarization control member, and
the first opening is provided with a first holder configured to hold an end portion of the support plate.

4. The virtual image display apparatus according to claim 3, further comprising
a dustproof member configured to fix the sealing member to the lens barrel while reliably preventing dust from entering the first opening of the lens barrel.

5. The virtual image display apparatus according to claim 4, wherein
the dustproof member includes
a tape having elasticity and configured to temporarily fix the sealing member to the first opening of the lens barrel while reliably preventing dust from entering the first opening of the lens barrel, and
a first adhesive having fluidity that allows, before cured, adjustment of a position and a direction of the polarization control member with respect to the lens barrel and fixes, after cured, the position and the direction of the polarization control member with respect to the lens barrel.

6. The virtual image display apparatus according to claim 1, further comprising a support frame configured to support the image display panel,
wherein the lens barrel further includes a second holder configured to hold the support frame, and
the virtual image display apparatus further comprises a second adhesive that is curable at any timing and fixes the support frame to the second holder of the lens barrel in a state in which a position and a direction of the image display panel with respect to the lens barrel are adjusted.

7. The virtual image display apparatus according to claim 1,
wherein the lens barrel further includes a second opening through which the image light passing through the first lens exits, and
the first lens is configured to seal the second opening.

8. The virtual image display apparatus according to claim 7,
wherein the polarization control member is configured to convert the image light from the image display panel into circularly polarized light,
a half-silvered mirror is provided at a first optical surface of the first lens that is a surface facing the first opening,
a polarization conversion member configured to convert linearly polarized light into circularly polarized light and convert circularly polarized light into linearly polarized light is provided at a second optical surface of the first lens that is a surface facing the second opening, and
a polarization optical element configured to reflect first linearly polarized light and transmit second linearly polarized light is provided on an outer side of the polarization conversion member at the second optical surface.

9. The virtual image display apparatus according to claim 8,
wherein the first lens includes a pancake lens having a convex surface as the first optical surface and a concave surface as the second optical surface.

10. The virtual image display apparatus according to claim 8,
wherein the first lens includes a plano-convex lens having a convex surface as the first optical surface and a planar surface as the second optical surface, and
the virtual image display apparatus further comprises a second lens as a plano-concave lens having a concave surface as a third optical surface facing the first optical surface, and a planar surface as a fourth optical surface facing the first opening.

11. The virtual image display apparatus according to claim 1,
wherein the image display panel includes an organic light emitting diode (OLED) panel configured to generate the image light, and
the polarization control member includes a circularly polarizing element configured to convert the image light from the image display panel into circularly polarized light.

12. The virtual image display apparatus according to claim 1,
wherein the image display panel includes a liquid crystal panel configured to generate the image light, and
the polarization control member includes
a polarizing plate configured to extract a predetermined linearly polarized component of the image light from the image display panel as linearly polarized light, and
a quarter waveplate configured to convert the linearly polarized light into circularly polarized light.

13. An optical unit, comprising:
a lens barrel having a first opening through which image light passes;
a first lens fixed inside the lens barrel;
a sealing member fixed to the first opening and configured to seal the first opening; and
an image display panel fixed outside the lens barrel and configured to generate the image light to be output toward the first lens via the sealing member,
wherein the sealing member includes a polarization control member configured to convert the image light into predetermined polarized light.
